(19) United States
(12) Patent Application Publication
(10) Pub. No.: US 2007/0188074 A1
(43) Pub. Date: Aug. 16, 2007

(54) Flat fluorescent lamp and display device including the same

(75) Inventors: Don-Chan Cho, Seongnam-si (KR); Hae-Il Park, Seoul (KR); Jin-Seob Byun, Seoul (KR); Sang-Yu Lee, Yongin-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/494,054

(22) Filed: Jul. 27, 2006

(30) Foreign Application Priority Data
Feb. 13, 2006 (KR) 10-2006-0013582

(51) Int. Cl. H01J 1/62

(52) U.S. Cl. 313/493

(57) ABSTRACT

A flat fluorescent lamp and a display device including the same. The flat fluorescent lamp includes a lamp body that has a plurality of discharge spaces and generates light, electrodes that are formed at the both ends of the lamp body, and a plurality of cold spots that are formed on the rear surface of the lamp body.

### CROSS-REFERENCE RELATED APPLICATION

This Application claims priority from Korean Patent Application No. 10-2006-0013582 filed on Feb. 13, 2006, the contents of which are incorporated by reference herein in their entirety.

### BACKGROUND OF THE INVENTION

(a) Technical Field

The present disclosure relates to a flat fluorescent lamp and a display device including the same, and more particularly, to a flat fluorescent lamp that is capable of improving stability and durability and a display device including the same.

(b) Discussion of the Related Art

A variety of display devices are known. Particularly, the rapid development of semiconductor technology has led to a rapid increase in lightweight and compact liquid crystal displays having improved performance.

The liquid crystal display (LCD) has a small size, is light weight, and consumes low power. Accordingly, the LCD has been viewed as a replacement for the conventional cathode ray tube (CRT). Recently, the LCD has been widely used in information processing apparatuses and middle-sized and large-sized display apparatuses, such as, for example, television sets and monitors, as well as small-sized display apparatuses, such as mobile phones and personal digital assistants (PDAs).

Since the LCD display panel does not emit light, the LCD includes a backlight assembly for supplying light to the rear surface of the display panel. A large-sized LCD, such as a digital TV set, may include a backlight assembly having a plurality of tubular lamps. However, in this case, many elements are used, thus complicating the assembling method. In addition, it is difficult to uniformly supply the light to the display panel.

As the size of the LCD gradually increases, high brightness and excellent screen uniformity should be ensured. Accordingly, a display device including a surface light source unit, such as a flat fluorescent lamp, has been developed.

However, since the display device is often used in a standing state, the temperature of the upper side of the flat fluorescent lamp is relatively high due to heat generated at the surface light source unit, but the temperature of the lower side thereof is relatively low. In addition, the temperature of a portion having an electrode is higher than that of the other portions not having an electrode. Accordingly, in the conventional surface light source unit, temperature distribution is not uniform.

The surface light source unit may use a discharge gas containing mercury. When the temperature distribution of the surface light source unit is not uniform, mercury contained in the discharge gas is concentrated to a portion having a lower temperature. Accordingly, the amount of mercury is reduced in a portion having a high temperature, thereby generating a dark portion. In addition, mercury may be partially absorbed and a portion of the surface light source unit becomes pink (pinkish phenomenon).

### SUMMARY OF THE INVENTION

Embodiments of the present invention provide a flat fluorescent lamp that is capable of improving stability and durability by making a temperature distribution of the flat fluorescent lamp uniform to suppress a dark portion and a pinkish phenomenon from being generated, and a display device including the same.

According to an embodiment of the present invention, a flat fluorescent lamp includes a lamp body that has a plurality of discharge spaces and generates light, electrodes that are formed at the both ends of the lamp body, and a plurality of cold spots that are formed on the rear surface of the lamp body.

The lamp body may include a front light source substrate and a rear light source substrate, which face each other. The front light source substrate may include a plurality of channel parts which form the discharge spaces and a plurality of partition parts which partition the plurality of channel parts. The front light source substrate and the rear light source substrate may have a first side and a second side, on which the electrodes are formed, and a third side and a fourth side, which are parallel to the plurality of channel parts and perpendicular to the first side and the second side. The plurality of cold spots may be formed on the rear surface of the rear light source substrate in correspondence with the plurality of channel parts.

The plurality of cold spots may be arranged at the same intervals.

The closer the cold spots are to the first side and the second side, the narrower the interval may be between the cold spots.

The plurality of cold spots may be arranged in a range from the third side to a predetermined position, and the predetermined position may be about ½ to about 11/12 of the distance from the third side to the fourth side.

A channel part positioned at a predetermined distance from the third side may include the largest number of cold spots arranged in correspondence therewith. As a channel part is positioned farther from the channel part positioned at the predetermined distance, the number of the cold spots arranged in correspondence with that channel part may decrease. The predetermined distance may be about ¼ to about ⅖ of a length from the third side to the fourth side.

The electrodes may be external electrodes.

The cold spots may be made of carbon black or metal.

The cold spots may be formed by a spray method using a patterning mask.

The cold spots may be formed by a screen printing method.

The thickness of each of the cold spots may be in a range from about 0.1 mm to about 1 mm.

Each of the cold spots may have a circular shape and a diameter of about 1 mm to about 5 mm.

Accordingly, it is possible to suppress a dark portion and a pinkish phenomenon from being generated in the flat fluorescent lamp.

According to an embodiment of the present invention, a display device includes a display panel that displays an image, a flat fluorescent lamp that supplies light to the display panel, and receiving members that receive the display panel and the flat fluorescent lamp. The flat fluorescent lamp includes a lamp body that has a plurality of discharge spaces and generates light, electrodes that are formed at both ends of the lamp body, and a plurality of cold spots that are formed on the rear surface of the lamp body.

The flat fluorescent lamp may have a substantially uniform temperature in the channel parts during operation thereof.

### BRIEF DESCRIPTION OF THE DRAWINGS

Exemplary embodiments of the present invention can be understood in more detail from the following descriptions with reference to the attached drawings, in which:

FIG. 1 is a perspective view of a flat fluorescent lamp according to an embodiment of the present invention;

FIG. 2 is a bottom view of the flat fluorescent lamp of FIG. 1;

FIG. 3 is a bottom view of a flat fluorescent lamp according to an embodiment of the present invention;

FIG. 4 is a bottom view of a flat fluorescent lamp according to an embodiment of the present invention;

FIG. 5 is a bottom view of a flat fluorescent lamp according to an embodiment of the present invention;

FIG. 6 is an exploded perspective view of a display device including the flat fluorescent lamp of FIG. 1 according to an embodiment of the present invention;

FIG. 7 is a block diagram of a display panel of the display device of FIG. 6 and elements for driving the display panel according to an embodiment of the present invention; and

FIG. 8 is an equivalent circuit diagram of a pixel of the display panel of FIG. 7 according to an embodiment of the present invention.

### DETAILED DESCRIPTION OF THE EXEMPLARY EMBODIMENTS

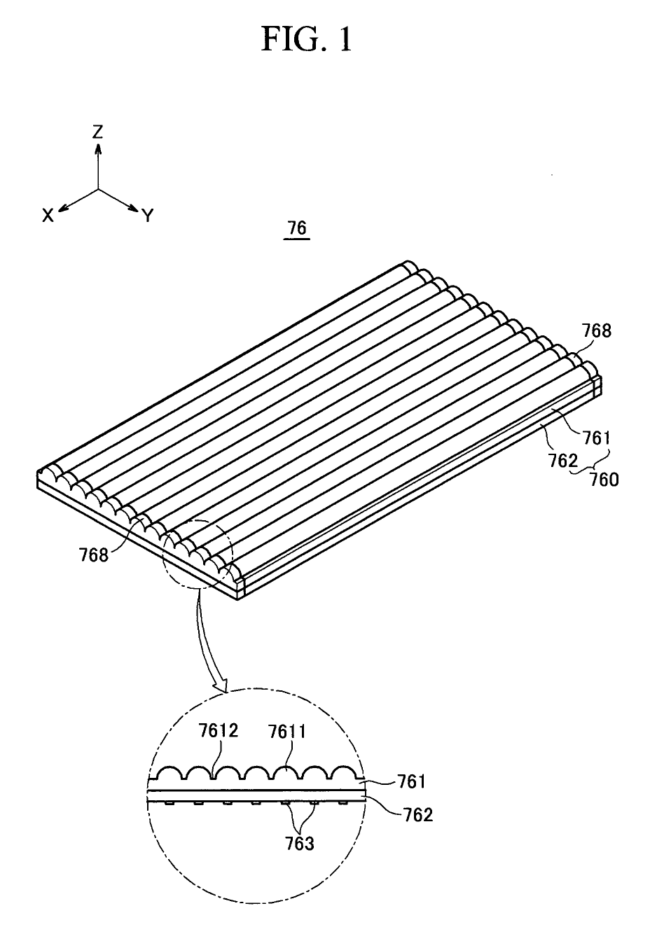

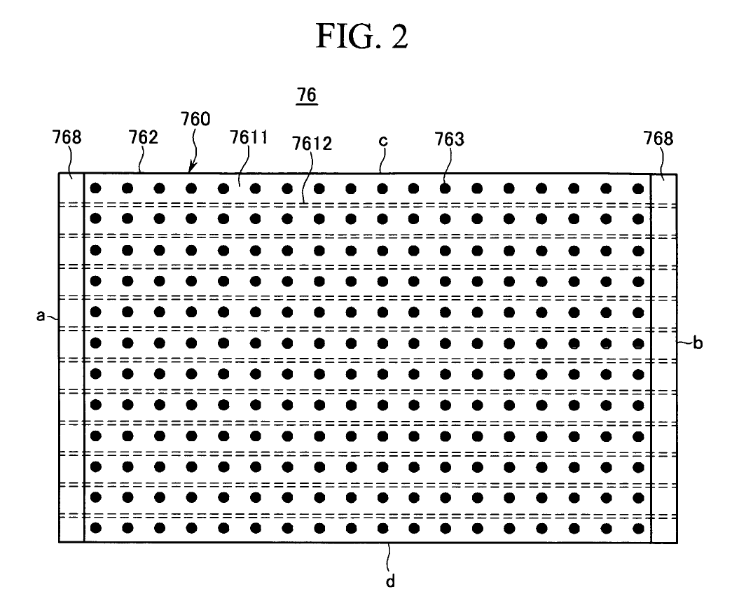

Exemplary embodiments of the present invention will now be described more fully hereinafter below in more detail with reference to the accompanying drawings. This invention may, however, be embodied in different forms and should not be construed as limited to the embodiments set forth herein FIG. 1 shows a flat fluorescent lamp 76 according to an embodiment of the present invention, and FIG. 2 shows the rear surface of the flat fluorescent lamp 76 of FIG. 1.

As shown in FIG. 1, the flat fluorescent lamp 76 includes a lamp body 760 that has a plurality of discharge spaces and emits light, electrodes 768 formed at the both ends of the lamp body 760, and cold spots 763 formed on the rear surface of the lamp body 760. The electrodes 768 are external electrodes.

The lamp body 760 includes a front light source substrate 761 and a rear light source substrate 762, which face each other. The front light source substrate 761 includes a plurality of channel parts 7611 forming the discharge spaces and a plurality of partition parts 7612 partitioning the channel parts 7611. Each of the partition parts 7612 is a boundary between adjacent channel parts 7611. The number of channel parts 7611 included in the flat fluorescent lamp 76 is not limited to that shown in FIG. 1, and may vary depending on the kind and the size of the flat fluorescent lamp 76. The cold spots 763 are formed on the rear surface of the rear light source substrate 762 along the channel parts 7611.

A discharge gas including, for example, mercury is filled in the discharge spaces of the channel parts 7611 and is discharged by the electrodes. The discharge gas may further include, for example, neon (Ne) or argon (Ar) in addition to mercury (Hg).

As shown in FIG. 2, the electrodes 768 are formed at a first side a and a second side b of the lamp body 760, and the channel parts 7611 are formed parallel to a third side c and a fourth side d and perpendicular to the first side a and the second side b. Since the flat fluorescent lamp 76 may be used for a middle- and large-sized display device mounted in a monitor or a TV set, the flat fluorescent lamp 76 is used in a state that the short sides thereof are vertical. Accordingly, the first side a of the lamp body 760 is a left side, the second side b thereof is a right side, the third side c thereof is an upper side, and the fourth side d thereof is a lower side.

The cold spots 763 are arranged at regular intervals and correspond to the channel parts 7611. The cold spots 763 are made of a material having high heat conductivity, such as carbon black or metal.

The number of the cold spots 763 may vary depending on the size of the flat fluorescent lamp 76 or the channel part 7611.

By forming the cold spots 763 on the rear surface of the lamp body 760 to adjust the temperature of the lamp body 760, it is possible to reduce a temperature difference between the upper and lower sides of the lamp body 760. Accordingly, it is possible to make the mercury vapor pressure of the channel parts 7611 relatively uniform. Since mercury contained in the discharge gas, which moves from a portion having a high temperature to a portion having a low temperature, is concentrated to the peripheries of the cold spots 763 that are uniformly arranged on the rear surface of the lamp body 760, it is possible to suppress mercury from moving between the channel parts and to prevent the mercury distribution from being biased to a specific portion. Accordingly, it is possible to suppress a dark portion and a pinkish phenomenon from being generated in the flat fluorescent lamp 76.

In order to adjust the temperature of the lamp body 760 to suppress the movement of mercury, the cold spots 763 may be formed with a circular shape. Each cold spot 763 has a diameter of about 1 mm to about 5 mm, taking into consideration the size of the channel part 7611. When the size of the cold spot 763 is less than about 1 mm or greater than about 5 mm, a temperature adjusting effect may deteriorate.

Each cold spot 763 has a thickness of about 0.1 mm to about 1 mm. When the thickness of the cold spot 763 is less than about 0.1 mm, the heat of the lamp body 760 is radiated and thus the temperature adjusting effect deteriorates. When the thickness of the cold spot 763 is greater than about 1 mm, the overall thickness of the flat fluorescent lamp 76 overly increases.

A method of forming the cold spots 763 on the rear surface of the rear light source substrate 762 will hereinafter be described.

The cold spots 763 attached to the rear surface of the lamp body 760 may be formed by a spray method using a patterning mask. That is, the patterning mask having the same pattern as that of the cold spots 763 to be formed on the rear surface of the lamp body 760 is manufactured and mounted on the rear surface of the lamp body 760, and a material having high heat conductivity is sprayed by the spray method to form the cold spots 763. The cold spots 763 may alternatively be formed by a screen printing method.

Since the cold spots 763 can be attached to the rear surface of the lamp body 760 by a relatively simple process, it is possible to improve stability and durability without deteriorating productivity of the flat fluorescent lamp 76.

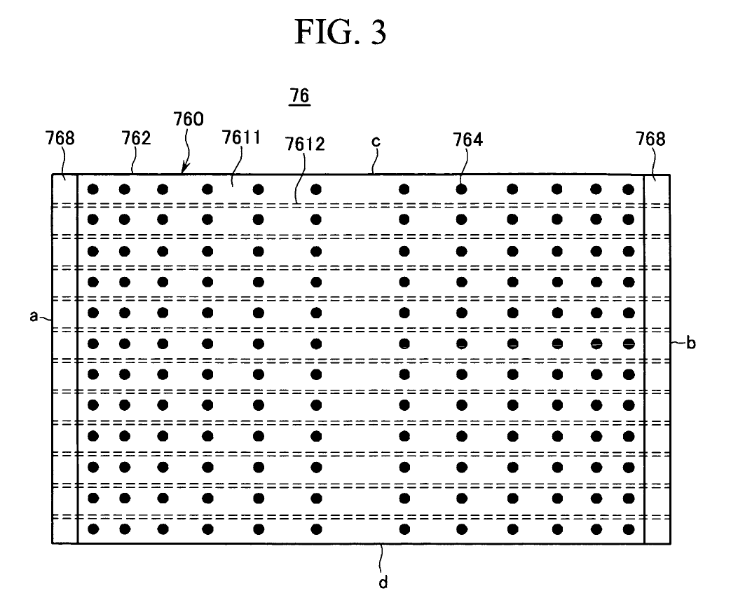

An embodiment of the present invention will be described with reference to FIG. 3. FIG. 3 shows the rear surface of a flat fluorescent lamp 76 according to an embodiment of the present invention.

As shown in FIG. 3, as the cold spots 764 are closer to the first side a and the second side b, the interval between the cold spots 764 becomes narrower.

That is, since a high level of heat is generated at the electrodes 768 formed at the first side a and the second side b of the lamp body 760, the cold spots 764 are more densely arranged near the first side a and the second side b. It is therefore possible to uniformly adjust the temperature of the lamp body 760.

Accordingly, it is possible to make the mercury distribution of the lamp body 760 more uniform upon the operation of the flat fluorescent lamp 76. Accordingly, it is possible to suppress the dark portion and the pinkish phenomenon from being generated in the flat fluorescent lamp 76.

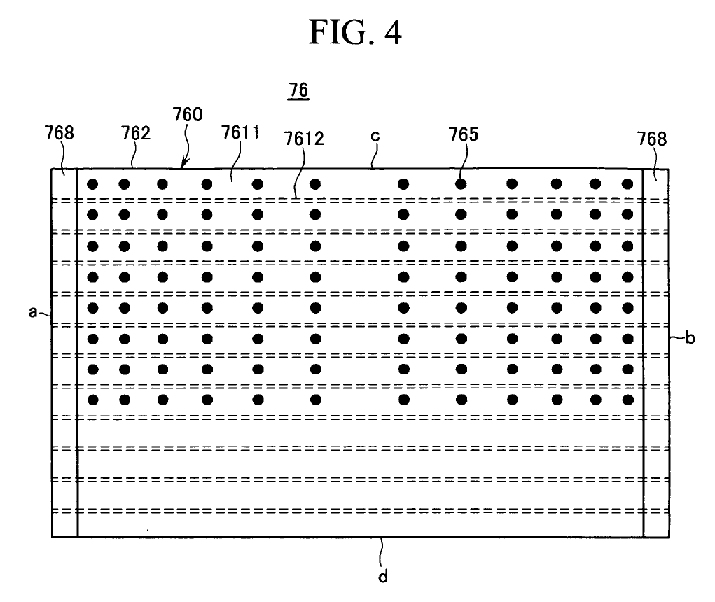

An embodiment of the present invention will be described with reference to FIG. 4. FIG. 4 shows the rear surface of a flat fluorescent lamp 76 according to an embodiment of the present invention.

As shown in FIG. 4, the cold spots 765 are formed only in a range from the third side c of the rear light source substrate 762 to a predetermined position. The predetermined position is about ½ to about 11/12 of the length from the third side c to the fourth side d. That is, the cold spots 765 are not attached to the rear surface of the rear light source substrate 762 corresponding to channel parts 7611 positioned at the lower side of the lamp body 760.

Since the temperature of the lower side of the flat fluorescent lamp 76 when used in a standing state is lower than that of the upper side thereof, it is possible to efficiently reduce the temperature difference between the upper side and the lower side thereof by arranging the cold spots 765 only on the upper side of the flat fluorescent lamp 76.

Accordingly, it is possible to make the mercury distribution of the lamp body 760 more uniform upon the operation of the flat fluorescent lamp 76. Accordingly, it is possible to suppress the dark portion and the pinkish phenomenon from being generated in the flat fluorescent lamp 76.

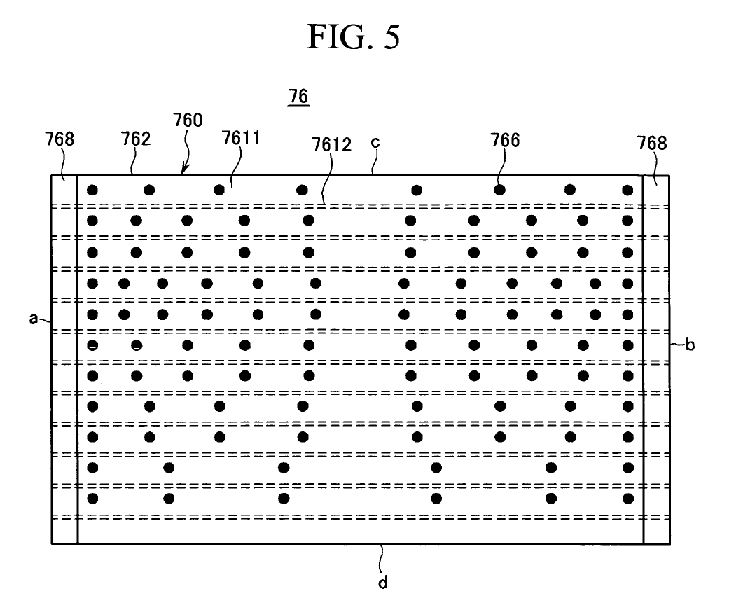

An embodiment of the present invention will be described with reference to FIG. 5. FIG. 5 shows the rear surface of a flat fluorescent lamp 76 according to an embodiment of the present invention.

As shown in FIG. 5, the number of cold spots 766 varies depending on the channel part 7611. That is, a channel part 7611 positioned at a predetermined distance from the third side c, has the largest number of cold spots 766. The farther a channel part 7611 is from the channel part 7611 having the largest number of cold spots 766, (i.e., the channel part 7611 positioned at the predetermined distance from the third side c), the fewer the number of cold spots 766 arranged in correspondence with the channel part 7611. The predetermined distance is about ¼ to about ⅖ of the length from the third side c to the fourth side d. That is, the number of cold spots 766 formed on the rear surface of the rear light source substrate 762 is largest in the channel part 7611 that is positioned at about a third of the length from the upper side to the lower side of the lamp body 760, and the farther a channel part 7611 is from the channel part 7611 positioned at the predetermined distance from the third side c, the smaller the number of the cold spots 766 arranged in correspondence with that channel part 7611.

In the flat fluorescent lamp 76 that is used in the standing state, although the temperature gradually increases from the lower side to the upper side by the movement of the heat, the heat is smoothly radiated in a portion closest to the third side c, that is, an uppermost channel part 7611. Thus, the channel part 7611 positioned at about ⅓ the length from the third side c to the fourth side d has the highest temperature.

Accordingly, in the flat fluorescent lamp 76 according to the embodiment described in connection with FIG. 5, the largest number of cold spots 766 are arranged in the channel part 7611 having the highest temperature. The farther a channel part 7611 is from the channel part 7611 having the highest temperature, the smaller the number of cold spots 766 arranged in correspondence with the channel part 7611. Accordingly, it is possible to efficiently reduce the temperature difference in the lamp body 760.

Also, as shown in FIG. 5, the closer the channel part 7611 is to the first side a and the second side b, the denser the cold spots 766 are arranged. In addition, the cold spots 766 may be omitted from a channel part(s) 7611 positioned at the lower side of the lamp body 760.

Accordingly, it is possible to improve the temperature adjusting effect of the lamp body 760 using the cold spot 766 and to efficiently make the mercury distribution of the lamp body 760 uniform upon the operation of the flat fluorescent lamp 76.

In addition, the above-described embodiments may be combined.

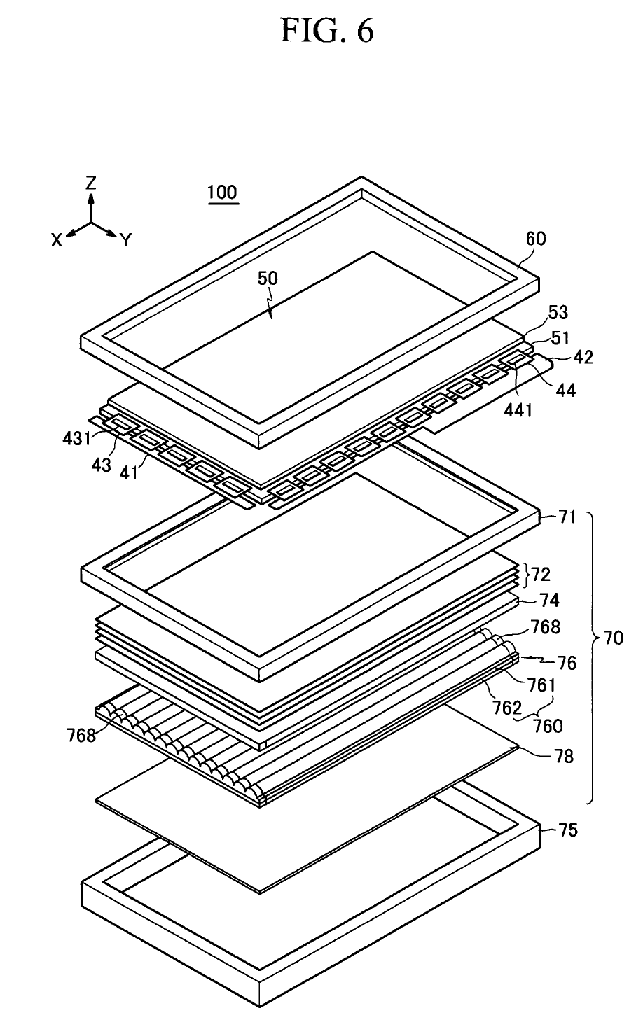

FIG. 6 shows a display device 100 including the flat fluorescent lamp 76 according to any of the above-described embodiments of the present invention. Although a liquid crystal display panel is shown as a display panel 50 used for the display device 100 in FIG. 6, the liquid crystal display panel is exemplary and the present invention is not limited thereto. A light receiving display panel may be used.

As shown in FIG. 6, the display device 100 includes a backlight assembly 70 for supplying light, and the display panel 50 for receiving the light and displaying an image. The display device 100 further includes receiving members 60, 71, and 75 for receiving elements including the display panel 50. The receiving members include the first receiving member 71 and the second receiving member 75 for configuring the backlight assembly 70, and the third receiving member 60 for fixing the display panel 50 to the backlight assembly 70. Although both the first receiving member 71 and the second receiving member 75 are used in FIG. 6, this structure is exemplary and the present invention is not limited thereto. Accordingly, at least one of the first receiving member 71 and the second receiving member 75 may be used.

The display device 100 further includes printed circuit boards (PCBs) 41 and 42 for supplying driving signals to the display panel 50, and driver integrated circuit packages (driver IC package) 43 and 44 for electrically connecting the PCBs 41 and 42 and the display panel 50. The driver IC packages 43 and 44 may be formed of, for example, a chip on film (COF) or a tape carrier package (TCP). The PCBs include the gate PCB 41 and the data PCB 42. The driver IC packages include the gate driver IC package 43 for connecting the display panel 50 and the gate PCB 41, and the data driver IC package 44 for connecting the display panel 50 and the data PCB 42.

The backlight assembly 70 includes a flat fluorescent lamp 76 for supplying the light, a prism 74 and a diffusion member 72 for improving brightness of the light emitted from the flat fluorescent lamp 76, and the first and second receiving members 71 and 75 for receiving and fixing those elements. The backlight assembly 70 may further include a reflection member 78 provided on the rear surface of the flat fluorescent lamp 76 to reflect the light toward the display panel 50.

The prism member 74 advances the light emitted from the flat fluorescent lamp 76 in a direction perpendicular to the display panel 50 to improve the brightness of the light, and the diffusion member 72 diffuses the light directed to the display panel 50 to prevent the light from being partially concentrated such that unevenness does not occur in the display panel 50 and the uniformity of the light is improved. The prism member 74 and the diffusion member 72 are used for improving the brightness of the light emitted from the flat fluorescent lamp 76. Alternatively, a diffusion plate may be used instead of the prism member 74, depending on the kind of the display device 100.

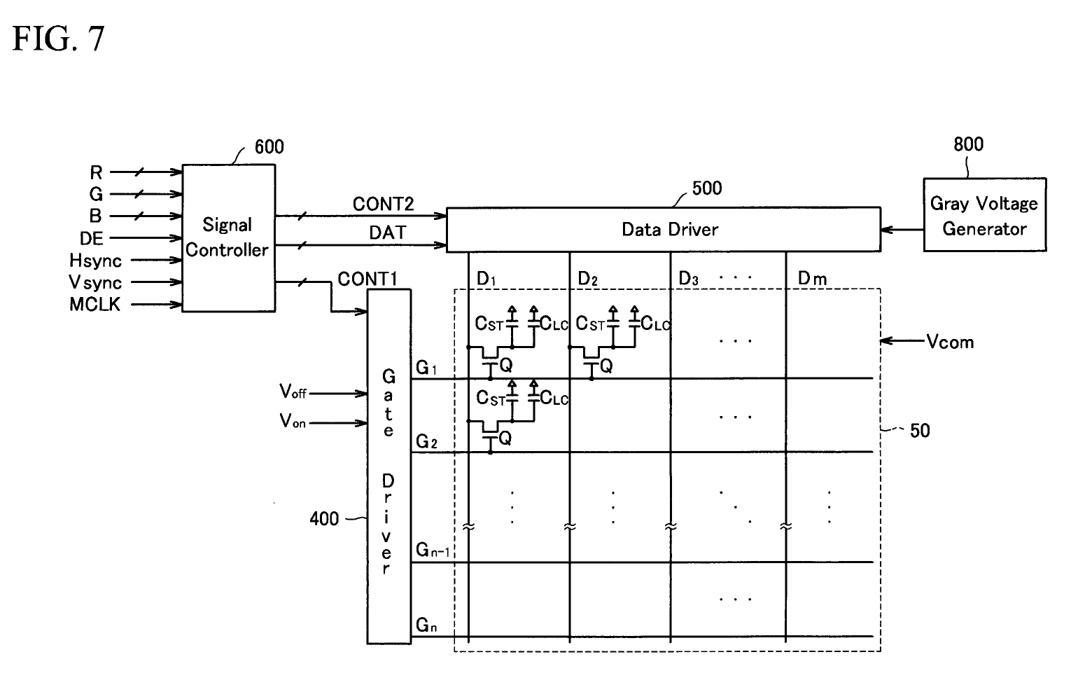

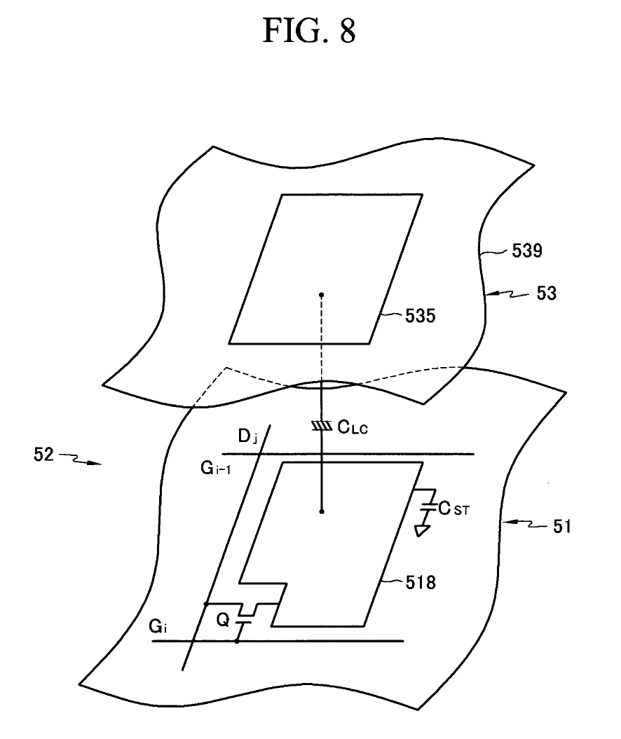

The display panel 50 includes a first display plate 51 and a second display plate 53 that faces the first display plate 51, with a liquid crystal layer 52 (shown in FIG. 8) interposed therebetween. The first display plate 51 is a rear plate and the second display plate 53 is a front plate. The driver IC packages 43 and 44 are connected to the first display plate 51. The gate driver IC package 43 is attached to one edge of the first display plate 51, and the gate driver IC package 43 includes an integrated circuit chip 431 for configuring a gate driver 400 (shown in FIG. 7). The data driver IC package 44 is attached to another edge of the first display plate 51 and the data driver IC package 44 includes an integrated circuit chip 441 for configuring a data driver 500 and a gray voltage generator 800 (shown in FIG. 7).

Hereinafter, the display panel 50 and elements for driving the same will be described in detail with reference to FIGS. 7 and 8.

As shown in FIGS. 7 and 8, the first display plate 51 includes a plurality of signal lines G₁ to Gₙ and D₁ to Dₘ. The first display plate 51 and the second display plate 53 include a plurality of pixels that are connected to a plurality of the signal lines G₁ to Gₙ and D₁ to Dₘ and arrayed substantially in a matrix.

The signal lines G₁ to Gₙ and D₁ to Dₘ include a plurality of gate lines G₁ to Gₙ for transmitting gate signals (sometimes, referred to as “scan signals”) and a plurality of data lines D₁ to Dₘ for transmitting data signals. The gate lines G₁ to Gₙ extend in parallel to each other substantially in a row direction, and the data lines D₁ to Dₘ extend in parallel to each other substantially in a column direction.

Each of the pixels includes a switching device Q connected to any one of the signal lines G₁ to Gₙ and D₁ to Dₘ, a liquid crystal capacitor C_{LC} connected thereto, and a storage capacitor C_{ST}. The storage capacitor C_{ST} may be omitted.

The switching device Q is a three-port device such as a thin film transistor disposed in the first display plate 51. The thin film transistor has a control port connected to one of the gate lines G₁ to Gₙ, an input port connected to one of the data lines D₁ to Dₘ, and an output port connected to the liquid crystal capacitor C_{LC} and the storage capacitor C_{ST}.

The signal controller 600 controls the operations of the gate driver 400 and the data driver 500. The gate driver 400 applies gate signals constructed by a combination of a gate-on voltage Vₒₙ and a gate-off voltage V_{off} to the gate lines G₁ to Gₙ, and the data driver 500 applies data voltages to the data lines D₁ to Dₘ. The gray voltage generator 800 generates two grayscale voltage sets corresponding to transmittance of the pixel and supplies the two grayscale voltage sets to the data driver 500 as the data voltages. One grayscale set has a positive value with respect to a common voltage V_{com}, and the other grayscale set has a negative value with respect to the common voltage V_{com}.

As shown in FIG. 8, two ports of the liquid crystal capacitor C_{LC} are a pixel electrode 518 of the first display plate 51 and a common electrode 539 of the second display plate 53, and the liquid crystal layer 52 interposed between the two electrodes 518 and 539 serves as a dielectric member. The pixel electrode 518 is connected to the switching device Q, and the common electrode 539 is disposed on the entire surface of the second display plate 53 to receive the common voltage V_{com}. Unlike FIG. 8, the common electrode 539 may be disposed on the first display plate 51, and at least one of the two electrodes 518 and 539 may be formed in a shape of a line or bar. A color filter 535 for applying color to the transmitted light is formed on the second display plate 53. Unlike FIG. 8, the color filter 535 may be formed on the first display plate 51.

The storage capacitor C_{ST} having an auxiliary function for the liquid crystal capacitor C_{LC} is constructed by overlapping a separate signal line (not shown) and the pixel electrode 518 provided to the first display plate 51 with an insulating member interposed therebetween, and a predetermined voltage such as the common voltage V_{com} is applied to the separate signal line. Alternatively, the storage capacitor C_{ST} may be constructed by overlapping the pixel electrode 518 and the gate line G₁ to Gₙ disposed just above with an insulting member interposed therebetween.

A polarizer (not shown) for polarizing the light is attached to the outer surface of at least one of the plates 51 and 53 of the display panel 50.

When the thin film transistor which is a switching element is turned on, an electric field is generated between the pixel electrode 518 and the common electrode 539. Due to the electric field, alignment angles of the liquid crystal layer 52 interposed between the first display plate 51 and the second display plate 53 change, so that transmittance of light changes. As a result, a desired image can be obtained.

As described above, according to the embodiments of the present invention, it is possible to improve stability and durability of a flat fluorescent lamp.

By forming cold spots on the rear surface of a lamp body to adjust the temperature of the lamp body, it is possible to reduce a temperature difference between the upper and lower sides of the lamp body. Accordingly, it is possible to make the mercury vapor pressure of channel parts relatively uniform. Since mercury contained in the discharge gas, which moves from a portion having a high temperature to a portion having a low temperature, is concentrated to the peripheries of the cold spots that are uniformly arranged on the rear surface of the lamp body, it is possible to suppress mercury from moving between the channel parts and to prevent the mercury distribution from being biased to a specific portion. Accordingly, it is possible to suppress a dark portion and a pinkish phenomenon from being generated in the flat fluorescent lamp.

According to an embodiment, the closer the cold spots are to an electrode that generates heat, the denser the cold spots are arranged in correspondence with the channel part. Accordingly, it is possible to uniformly adjust the temperature of the lamp body.

Since the temperature of the lower side of the flat fluorescent lamp that is used in a standing state is lower than that of the upper side thereof, it is possible to efficiently reduce the temperature difference between the upper side and the lower side by arranging the cold spots only at the upper side thereof.

According to an embodiment, the largest number of cold spots are disposed in a channel part having a highest temperature, and the farther a channel part is from the channel part having the highest temperature, the smaller the number of cold spots in that channel part. Accordingly, it is possible to efficiently reduce the temperature difference in the lamp body.

Accordingly, it is possible to make the mercury distribution of the lamp body more uniform upon the operation of the flat fluorescent lamp. Accordingly, it is possible to suppress the dark portion and the pinkish phenomenon from being generated in the flat fluorescent lamp.

Since the cold spots can be attached to the rear surface of the lamp body by a relatively simple process, it is possible to improve stability and durability without deteriorating productivity of the flat fluorescent lamp.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. A flat fluorescent lamp comprising:
a lamp body including a plurality of discharge spaces;
electrodes formed at ends of the lamp body; and
a plurality of cold spots formed on a rear surface of the lamp body.

2. The flat fluorescent lamp of claim 1, wherein:
the lamp body comprises a front light source substrate and a rear light source substrate, wherein the front and rear light source substrates face each other;
the front light source substrate includes a plurality of channel parts forming the discharge spaces and a plurality of partition parts partitioning the plurality of channel parts; and
the plurality of cold spots are formed on the rear light source substrate corresponding to the plurality of channel parts.

3. The flat fluorescent lamp of claim 2, wherein the lamp body includes a first side and a second side, on which the electrodes are formed, and a third side and a fourth side, which are parallel to the plurality of channel parts and perpendicular to the first side and the second side.

4. The flat fluorescent lamp of claim 2, wherein the plurality of cold spots are arranged at the same intervals.

5. The flat fluorescent lamp of claim 3, wherein an interval between the cold spots is narrower as the cold spots are closer to the first side and the second side.

6. The flat fluorescent lamp of claim 3, wherein:
the plurality of cold spots are arranged in a range from the third side to a predetermined position, and
the predetermined position is about ½ to about 11/12 of a distance from the third side to the fourth side.

7. The flat fluorescent lamp of claim 3, wherein:
a channel part positioned at a predetermined distance from the third side includes the largest number of the plurality of cold spots arranged in correspondence therewith; and
as a channel part is positioned farther from the channel part positioned at the predetermined distance, the number of cold spots arranged in correspondence with the farther positioned channel part decreases.

8. The flat fluorescent lamp of claim 7, wherein the predetermined distance is about ¼ to about ⅖ of a distance from the third side to the fourth side.

9. The flat fluorescent lamp of claim 1, wherein the electrodes are external electrodes.

10. The flat fluorescent lamp of claim 1, wherein the cold spots include carbon black or metal.

11. The flat fluorescent lamp of claim 1, wherein the cold spots are formed by a spray method using a patterning mask.

12. The flat fluorescent lamp of claim 1, wherein the cold spots are formed by a screen printing method.

13. The flat fluorescent lamp of claim 1, wherein a thickness of each of the cold spots is in a range from about 0.1 mm to about 1 mm.

14. The flat fluorescent lamp of claim 1, wherein each of the cold spots has a circular shape and a diameter of about 1 mm to about 5 mm.

15. A display device comprising:
a display panel for displaying an image;
a flat fluorescent lamp for supplying light to the display panel; and
receiving members for receiving the display panel and the flat fluorescent lamp,
wherein the flat fluorescent lamp comprises:
a lamp body including a plurality of discharge spaces,
electrodes formed at ends of the lamp body, and
a plurality of cold spots formed on a rear surface of the lamp body.

16. The display device of claim 15, wherein:
the lamp body comprises a front light source substrate and a rear light source substrate, wherein the front and rear light source substrates face each other;
the front light source substrate includes a plurality of channel parts forming the discharge spaces and a plurality of partition parts partitioning the plurality of channel parts; and
the plurality of cold spots are formed on the rear light source substrate corresponding to the plurality of channel parts.

17. The display device of claim 16, wherein the lamp body includes a first side and a second side, on which the electrodes are formed, and a third side and a fourth side, which are parallel to the plurality of channel parts and perpendicular to the first side and the second side.

18. The display device of claim 16, wherein the plurality of cold spots are arranged at the same intervals.

19. The display device of claim 17, wherein an interval between the cold spots is narrower as the cold spots are closer to the first side and the second side.

20. The display device of claim 17, wherein:
the plurality of cold spots are arranged in a range from the third side to a predetermined position, and
the predetermined position is about ½ to about 11/12 of a distance from the third side to the fourth side.

21. The display device of claim 17, wherein:
a channel part positioned at a predetermined distance from the third side includes the largest number of the plurality of cold spots arranged in correspondence therewith; and
as a channel part is positioned farther from the channel part positioned at the predetermined distance, the number of cold spots arranged in correspondence with the farther positioned channel part decreases.

22. The display device of claim 21, wherein the predetermined distance is about ¼ to about ⅖ of a distance from the third side to the fourth side.

23. The display device of claim 16, wherein the flat fluorescent lamp has a substantially uniform temperature in the channel parts during operation thereof.

24. The display device of claim 15, wherein the cold spots have a circular shape, a diameter of about 1 mm to about 5 mm, and a thickness of about 0.1 mm to about 1 mm.
